(19) United States
(12) Patent Application Publication
(10) Pub. No.: US 2016/0007121 A1
(43) Pub. Date: Jan. 7, 2016

(54) DUAL VOICE COIL SPEAKER FOR MOBILE ELECTRONIC DEVICE

(71) Applicants: Chien-Kuo Hung, Taoyuan City (TW); Chien-Hsiang Hung, Taoyuan City (TW)

(72) Inventors: Chien-Kuo Hung, Taoyuan City (TW); Chien-Hsiang Hung, Taoyuan City (TW)

(21) Appl. No.: 14/753,025

(22) Filed: Jun. 29, 2015

(30) Foreign Application Priority Data
Jul. 1, 2014 (TW) 103211652

(51) Int. Cl. H04R 9/04

(52) U.S. Cl. CPC H04R 9/04; H04R 2499/11

(57) ABSTRACT

A dual voice coil speaker for mobile electronic device includes a housing, a magnet mounted inside the housing, a diaphragm suspending in the housing near one end of the magnet and a dual voice coil bonded to an inner surface of the to surround the magnet. The dual voice coil is formed by arranging two varnished wires into an annular shape to provide four terminals that are respectively electrically connected to four lead wires in the housing in a parallel or series manner so that the two voice coils of the dual voice coil can be separately or concomitantly operated to meet different application requirements.

### BACKGROUND OF THE INVENTION

(a) Field of the Invention

The present invention relates speaker technology, and more particularly to a dual voice coil speaker for use in a mobile phone or any other mobile electronic device.

(b) Description of the Prior Art

Commercial mobile phones are commonly configured to provide two speakers, one for receiver application to provide a relatively lower sound volume, the other for ringtone or multimedia application to provide a relatively higher sound volume. Using two speakers in a mobile phone greatly increases the cost of the mobile phone and occupies much internal space of the mobile phone. Under the market environment of creating mobile phones having light and thin characteristics, the prior art technique of using two speakers will be at a disadvantage. Enabling multimedia and receiver functions to share one single speaker can overcome the drawbacks of the aforesaid prior art technique.

However, the human ear can simply withstand a limited sound volume at a near distance. If a ringtone or multimedia speaker is directly used for receiver application, the low impedance voice coil of the speaker can output high sound volume, causing damage to the user's eardrum. How to provide a speaker that can be used for ringtone or multimedia application to output a large sound volume as well as receiver application to output a small sound volume without causing damage to the eardrum is the problem the invention has overcome.

Further, according to known technical data, speakers of dual voice coil type use one single magnet to mate with two separated voice coils, and each voice coil is bonded with one respective diaphragm in one respective housing. Due to the use of two diaphragms, the dimension of a speaker of this kind cannot be significantly minimized to provide optimal light and thin characteristics.

### SUMMARY OF THE INVENTION

The present invention has been accomplished under the circumstances in view. It is therefore the main object of the present invention to provide a dual voice coil speaker, which is practical for use in a mobile electronic device such as mobile phone or the like, allowing ringtone, multimedia and receiver functions to share the speaker and saving the cost and internal space of the mobile electronic device.

To achieve this and other objects of the present invention, a dual voice coil speaker comprises a housing, a magnet mounted inside the housing, a diaphragm suspending in the housing near one end of the magnet, and a dual voice coil bonded to an inner surface of the diaphragm around the magnet. The housing has four lead wires embedded therein. The dual voice coil is made by arranging two varnished wires into an annular shape to surround the magnet. Each varnished wire has two opposite ends thereof respectively terminating in positive and negative terminals, and thus, the dual voice coil has four terminals respectively electrically connected to the four lead wires in the housing. The two varnished wires of the dual voice coil can be selectively connected in parallel or in series.

By means of arranging two varnished wires of different lengths into a dual voice coil enables the two voice coils of the dual voice coil to have different impedances. When used in a mobile phone, the voice coil having a relatively smaller impedance can be used for ringtone or multimedia output to provide a relatively higher output volume; the voice coil having a relatively larger impedance can be used for receiver application to provide a relatively lower output volume. Thus, a mobile phone can use one single speaker for ringtone, multimedia and receiver applications. Further, the invention allows the mobile phone or mobile electronic device manufacturer to selectively connect the two voice coils of the dual voice coil in parallel or series. By means of connecting two of the four lead wires in the housing, the two varnished wires of the dual voice coil are connected in series to provide a relatively larger impedance for the input of one single sound source. On the contrary, the two varnished wires of the dual voice coil can be arranged in parallel for the input of two sound sources.

### BRIEF DESCRIPTION OF THE DRAWINGS

FIG. 1 is an exploded view of a dual voice coil speaker in accordance with the present invention.

FIG. 2 is a schematic assembly view of the present invention, illustrating the dual voice coil speaker assembled prior to installation of the protective covering.

FIG. 3 is a schematic sectional side view of the dual voice coil speaker in accordance with the present invention.

FIG. 4 is a schematic applied view of the present invention, illustrating the two varnished wires of the dual voice coil connected in parallel.

FIG. 5 is another schematic applied view of the present invention, illustrating the two varnished wires of the dual voice coil connected in series.

FIG. 6 is a schematic drawing illustrating still another application example of the dual voice coil speaker in accordance with the present invention.

FIG. 7 is a schematic drawing illustrating still another application example of the dual voice coil speaker in accordance with the present invention.

FIG. 8 is a schematic drawing illustrating a circular ring-shaped dual voice coil used with a circular cylindrical magnet in the dual voice coil speaker in accordance with the present invention.

FIG. 9 is a schematic drawing illustrating an oval ring-like dual voice coil used with an elongated cylindrical magnet in the dual voice coil speaker in accordance with the present invention.

FIG. 10 is an exploded view of the dual voice coil speaker shown in FIG. 9.

### DETAILED DESCRIPTION OF THE PREFERRED EMBODIMENTS

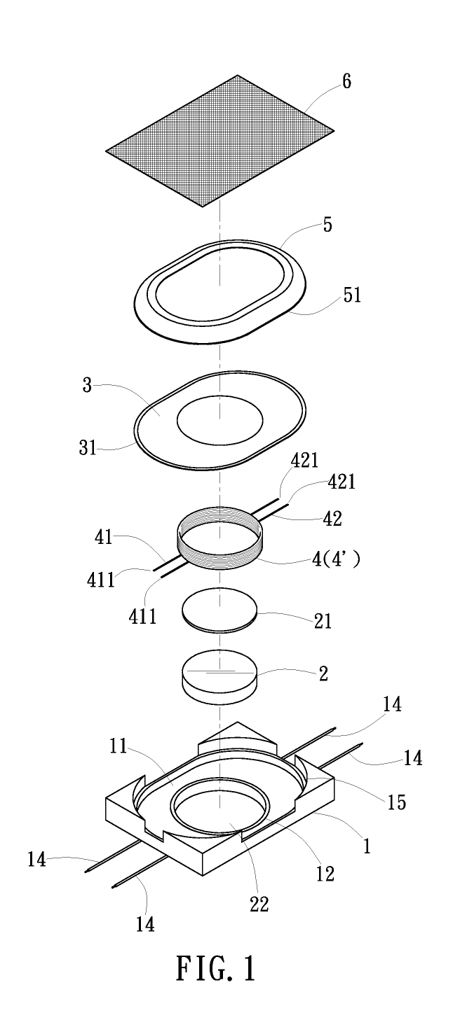

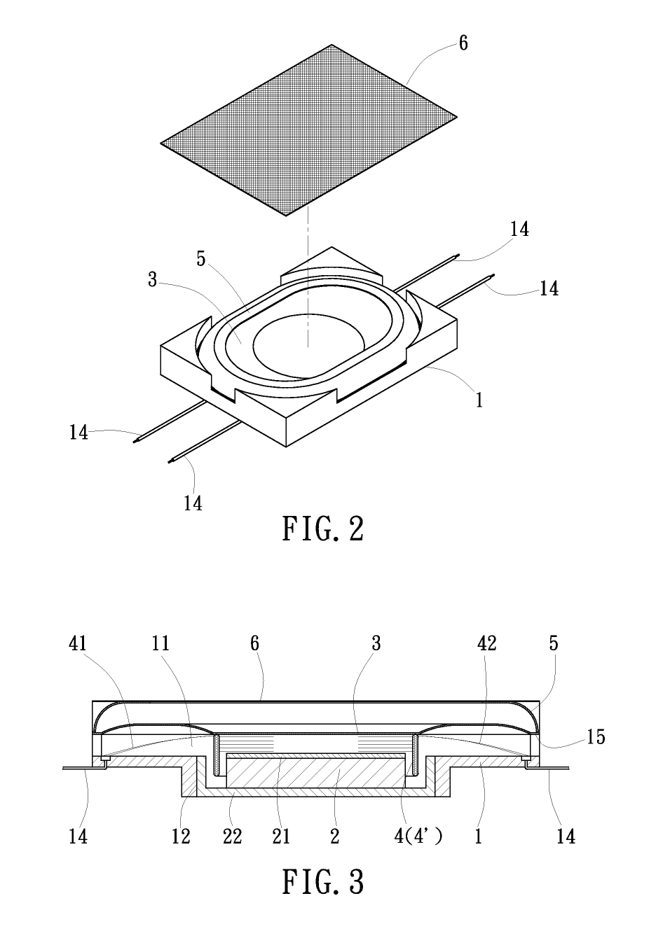

Referring to FIGS. 1, 2 and 3, a dual voice coil speaker in accordance with a first embodiment of the present is shown. The dual voice coil speaker comprises: a housing 1, a magnet 2 mounted inside the housing 1, a diaphragm 3 suspending in the housing 1 adjacent to one end (the top end) of the magnet 2, a dual voice coil 4,4′ joined to an inner surface of the diaphragm 3 around the magnet 2, a fixation member 5 fastened to the border area of the diaphragm 3, and a protective covering 6 fastened to one end face of the housing 1.

The housing 1 is a rectangular, circular or oval structure, comprising a recessed accommodation chamber 11 located in one end face thereof, and an opening 12 extended from the accommodation chamber 11 and cut through an opposing end face thereof. Further, each of two opposite lateral sides of the housing 1 has two lead wires 14 arranged therein and respectively extended to the accommodation chamber 11. These four lead wires 14 are provided for the connection of the dual voice coil 4,4′ respectively.

The magnet 2 can be configured to exhibit a circular cylindrical shape, elongated prism-like shape, cylindrical oval shape, or a prism of any other shapes. The magnet 2 is mounted in the opening 12 of the housing 1, having a front iron yoke 21 bonded to one end thereof adjacent to the diaphragm 3 and a rear iron yoke 22 bonded to an opposite side thereof. The rear iron yoke 22 can be a round cap adapted to simultaneously close the opening 12 of the housing 1.

The diaphragm 3 is a circular or oval thin film, having the border edge 31 thereof fixedly abutted against a bottom wall of the accommodation chamber 11 of the housing 1 or a step 15 around the accommodation chamber 11, and thus, the diaphragm 3 is suspended from a point near the magnet 2.

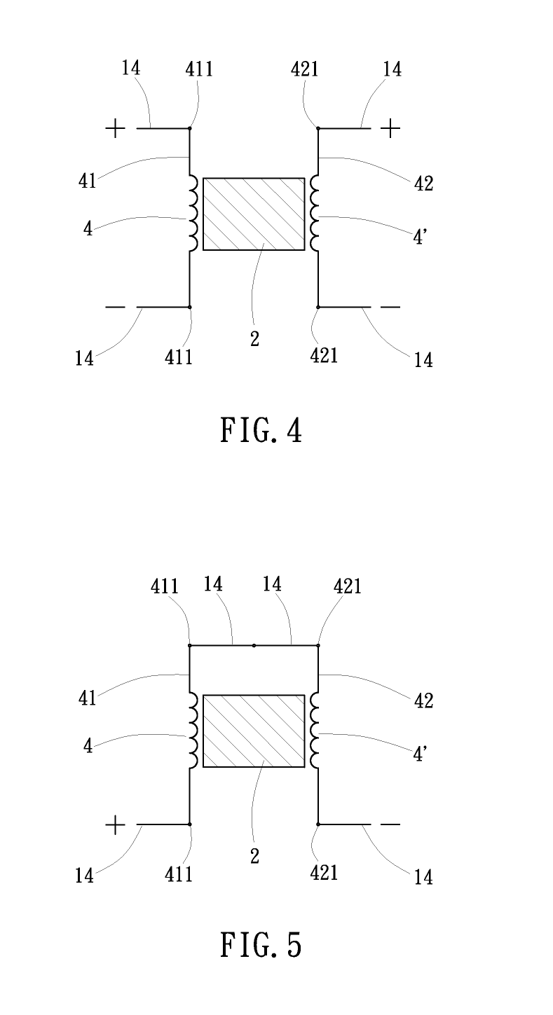

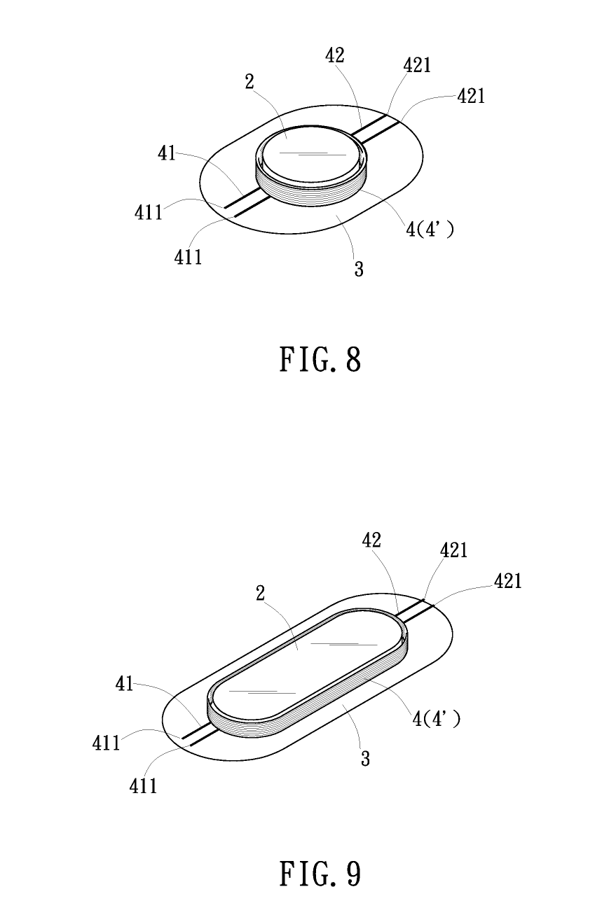

The dual voice coil 4,4′ is made by arranging two varnished wires 41,42 into an annular shape, elongated ring shape or oval annular shape with one end thereof fixedly bonded to an inner surface of the diaphragm 3 adjacent to the magnet 2, and thus, the dual voice coil 4,4′ surrounds the magnet 2 (see FIG. 3 and FIG. 8). Each of the two varnished wires 41,42 has two opposite ends thereof respectively terminating in opposing positive and negative terminals 411,421 that are respectively connected to the four lead wires 14 in the housing 1, thus, the two varnished wires 41,42 of the dual voice coil 4,4′ can be connected to power source in a parallel manner (see FIG. 4), or connected to power source in series (see FIG. 5).

The fixation member 5 is a hollow frame member fitting the shape of the diaphragm 3, having the border edge 51 thereof press-bonded to the border edge 31 of the diaphragm 3 to affix the border edge 31 of the diaphragm 3 to the housing 1. The protective covering 6 is made from a soft mesh or hard metal mesh and bonded to one end face of the housing 1 to protect the fixation member 5 and the diaphragm 3 in the accommodation chamber 11. When assembled, the dual voice coil speaker can be installed in a front side of a mobile phone, allowing the ringtone, multimedia and receiver functions to share the speaker.

In a first application example of the present invention as shown in FIG. 4, the two varnished wires 41,42 of the dual voice coil 4,4′ have different lengths and different impedances, in which, the voice coil 4 using a relatively shorter varnished wire 41 and having a relatively smaller impedance (e.g. 8Ω) can be used for ringtone or multimedia audio output to provide a relatively higher volume of output sound. On the contrary, the other voice coil 4′ using a relatively longer varnished wire 42 and having a relatively larger impedance (e.g. 16Ω) can be used for receiver voice output to provide a relatively lower volume of output sound. Thus, if the dual voice coil speaker is used in a mobile phone, the lead wires 14 of the housing 1 can be respectively connected to different sound sources, allowing the ringtone, multimedia and receiver functions to share the speaker.

The invention allows mobile phone or mobile communication device manufacturers to decide the desired speaker application mode. In the aforesaid first application mode as illustrated in FIG. 4, the lead wires 14 of the housing 1 are respectively connected to different sound sources, allowing the two voice coils of the dual voice coil 4,4′ to receive voice signals from different sound sources. In a second application example of the present invention, as shown in FIG. 5, two of the four lead wires 14 in the housing 1 are electrically connected together to have one end of one varnished wire 41 of the dual voice coil 4,4′ be electrically connected to one end of the other varnished wire 42 to provide a relatively larger impedance. Thus, after connected the two 16Ω voice coils of the dual voice coil 4,4′ in series, the impedance of the dual voice coil 4,4′ becomes 32Ω for the input of one single sound source.

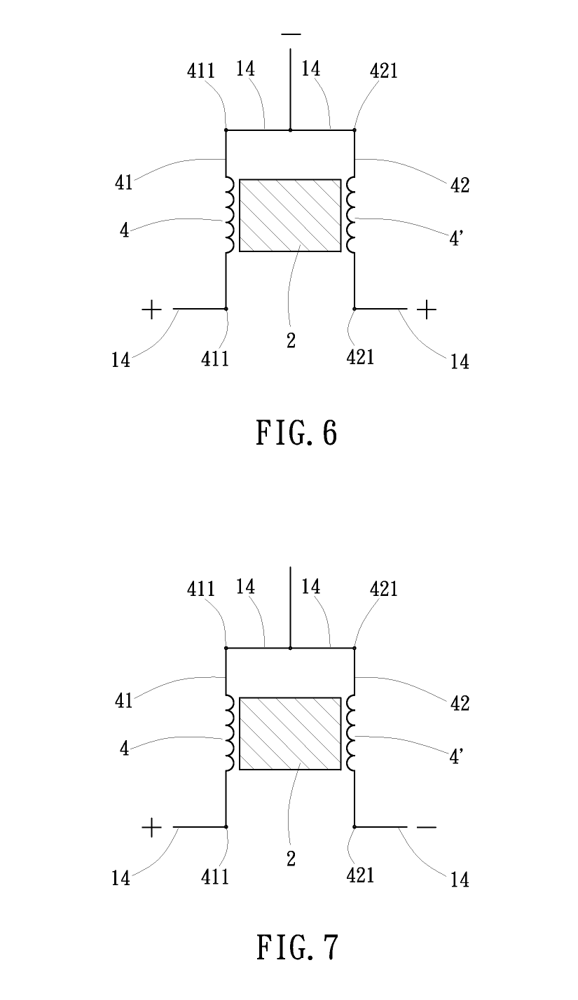

Further, the two varnished wires 41,42 can have the same length. In this case, changing the coupling relationship between the two lead wires 14 in the housing 1 relatively changes the impedance of the dual voice coil 4,4′ to satisfy different requirements for ringtone, multimedia and receiver applications. In still another application example, as shown in FIG. 6, the four lead wires 14 in the housing 1 are arranged to provide three sound source contacts. Thus, the circuit of the mobile phone or other mobile electronic device using the dual voice coil speaker can be designed to be conducted to the voice coil 4 or 4′ of one varnished wire 41 or 42, where the impedance of each voice coil 4 or 4′ is 16Ω. Thus, the voice coil 4 or 4′ has low impedance for ringtone or multimedia output. In still another application example, as shown in FIG. 7, the two varnished wires 41 and 42 are respectively arranged to form one respective voice coil 4 or 4′ having an impedance of 16Ω, and these two voice coils 4 and 4′ are connected in series to form a dual voice coil 4,4′ having an impedance of 32Ω. Thus, when the user picks up the phone, the dual voice coil speaker works as a receiver. By means of the implementation of a sound source circuit switching function, the mobile phone can simply use one single dual voice coil speaker of the invention to achieve voice output of different sound sources. Further, the impedance of the voice coil 4 or 4′ can be changed by adding a resistance to the respective varnished wire 41 or 42, for example, by means of adding a resistance to one varnished wire 41, the impedances of the two voice coils 4 and 4′ of the dual voice coil 4,4′ become different, and thus, the dual voice coil speaker can be used for receiver and multimedia applications.

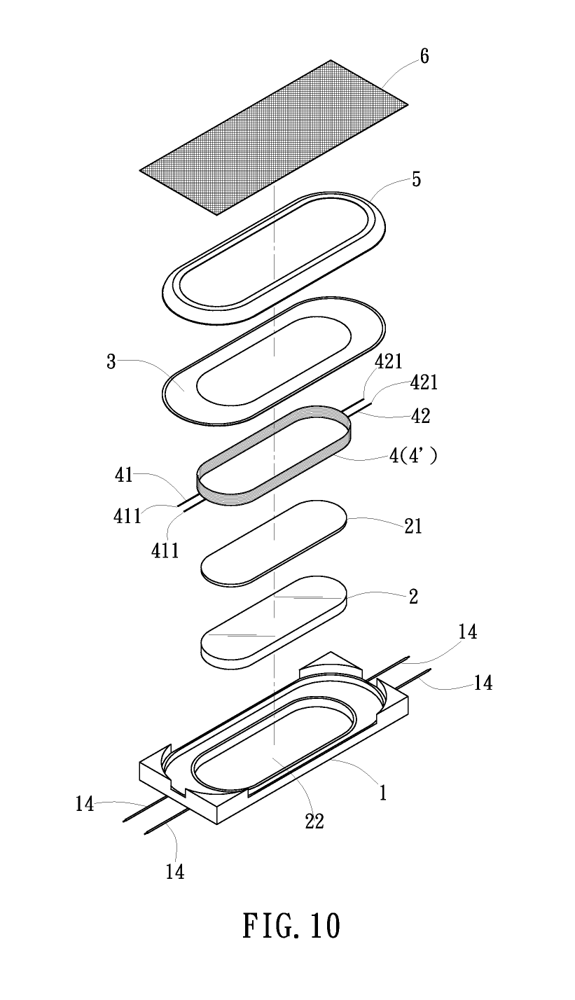

Further, a speaker to be mounted in a front side of a mobile phone for use as a receiver generally uses an oval or elongated diaphragm. If an oval or elongated diaphragm is used with a circular annular voice coil and a circular cylindrical magnet, the long distance between the voice coil and the two opposite ends of the diaphragm tends to cause double trills, resulting in abnormal sound quality. In order to eliminate this problem, as shown in FIG. 9 and FIG. 10, the dual voice coil 4,4′ can be configured to exhibit an oval ring or elongated ring shape; the magnet 2 can be shaped like an oval cylinder or elongated prism. The structures and mounting arrangement of the other component parts remain unchanged. Thus, the dual voice coil 4,4′ of the dual voice coil speaker of the present invention can effectively overcome the problem of double trills, and therefore, it is practical for use in a mobile phone.

What is claimed is:

1. A dual voice coil speaker, comprising: a housing, a magnet mounted inside said housing, a diaphragm suspended in said housing near one end of said magnet, and a dual voice coil bonded to an inner surface of said diaphragm to surround said magnet, said housing having four lead wires embedded therein, said dual voice coil comprising two varnished wires arranged into an annular shape around said magnet, each said varnished wire having two opposite ends thereof respectively terminating in opposing positive and negative terminals, the positive and negative terminals of said two varnished wires being respectively electrically connected to said four lead wires in said housing in a parallel or series manner.

2. The dual voice coil speaker as claimed in claim 1, wherein said two varnished wires have the same length.

3. The dual voice coil speaker as claimed in claim 1, wherein said two varnished wires have different lengths.

4. The dual voice coil speaker as claimed in claim 1, wherein said magnet is a circular cylindrical magnet; said dual voice coil has an annular shape surrounding said circular cylindrical magnet.

5. The dual voice coil speaker as claimed in claim 1, wherein said magnet has a cylindrical oval shape; said dual voice coil has an oval annular shape mating with the cylindrical oval shape of said magnet.

6. The dual voice coil speaker as claimed in claim 1, wherein said magnet is shaped like an elongated prism; said dual voice coil has an elongated ring shape mating with the shape of elongated prism of said magnet.

7. The dual voice coil speaker as claimed in claim 4, wherein said magnet comprises a front iron yoke bonded one end thereof near said diaphragm, and a rear iron yoke bonded to an opposite end thereof.

8. The dual voice coil speaker as claimed in claim 5, wherein said magnet comprises a front iron yoke bonded one end thereof near said diaphragm, and a rear iron yoke bonded to an opposite end thereof.

9. The dual voice coil speaker as claimed in claim 6, wherein said magnet comprises a front iron yoke bonded one end thereof near said diaphragm, and a rear iron yoke bonded to an opposite end thereof.

10. The dual voice coil speaker as claimed in claim 7, further comprising a fixation member, said fixation member being a hollow frame member fitting the shape of said diaphragm and having the border edge thereof press-bonded to the border edge of said diaphragm to affix said diaphragm to said housing.

11. The dual voice coil speaker as claimed in claim 8, further comprising a fixation member, said fixation member being a hollow frame member fitting the shape of said diaphragm and having the border edge thereof press-bonded to the border edge of said diaphragm to affix said diaphragm to said housing.

12. The dual voice coil speaker as claimed in claim 9, further comprising a fixation member, said fixation member being a hollow frame member fitting the shape of said diaphragm and having the border edge thereof press-bonded to the border edge of said diaphragm to affix said diaphragm to said housing.

13. The dual voice coil speaker as claimed in claim 10, further comprising a protective covering bonded to one end face of said housing.

14. The dual voice coil speaker as claimed in claim 11, further comprising a protective covering bonded to one end face of said housing.

15. The dual voice coil speaker as claimed in claim 12, further comprising a protective covering bonded to one end face of said housing.
